(19) United States
(12) Patent Application Publication
(10) Pub. No.: US 2026/0245586 A1
(43) Pub. Date: Aug. 20, 2026

(54) MAGNETIC RECORDING MEDIUM WITH MAGNETIC CAPPING LAYER CONTAINING CARBON AND A MAGNETIC RECORDING APPARATUS FOR USE THEREWITH

(71) Applicant: Western Digital Technologies, Inc., San Jose, CA (US)

(72) Inventors: Yoshihiro Ikeda, San Jose, CA (US); Ashok Venkatesh Kulkarni, Pleasanton, CA (US); Prakash Mani, San Jose, CA (US)

(21) Appl. No.: 19/058,476

(22) Filed: Feb. 20, 2025

(51) Int. Cl. G11B 5/65; G11B 5/66; G11B 5/667; G11B 5/851

(52) U.S. Cl. CPC G11B 5/656; G11B 5/667; G11B 5/672; G11B 5/851

(57) ABSTRACT

Various apparatuses, devices, methods, and media are disclosed for perpendicular magnetic recording (PMR) or enhanced PMR (ePMR) where a magnetic recording medium includes a magnetic capping layer with carbon. The capping layer may include, e.g., an amount of carbon providing an atomic percentage (at. %) in the media in the range of 10-30 at. %. In one particular example, the capping layer is 54Co-21.5Pt-24.5C. In some examples, the capping layer is CoPtC—X, where X is one or more of B, Cr, Ru, O, and Ta. For instance, the capping layer may be 60.5Co-2.5Cr-24Pt-3Ru-10C. The magnetic recording medium may include additional layers such as a soft underlayer (SUL) on the substrate, a seed layer on the SUL, an interlayer on the seed layer, and an underlayer on the interlayer, with the magnetic recording layer on the interlayer. A magnetic capping layer with carbon may also be configured for heat-assisted magnetic recording (HAMR) media.

### FIELD

The disclosure relates, in some aspects, to magnetic recording media and to magnetic recording apparatus for use with magnetic recording media. More specifically, but not exclusively, the disclosure relates to magnetic recording media configured for use with perpendicular magnetic recording (PMR) or enhanced PMR (ePMR).

### INTRODUCTION

Magnetic storage systems, such as a hard disk drive (HDD), are utilized in a wide variety of devices in stationary and mobile computing environments. Examples of devices that incorporate magnetic storage systems include data center servers, desktop computers, portable notebook computers, portable hard disk drives, high-definition television (HDTV) receivers, television set-top boxes, video game consoles, and portable media players.

A typical disk drive includes magnetic storage media in the form of one or more flat disks. The disks are generally formed of few main substances, namely, a substrate material that gives it structure and rigidity, a magnetic recording layer that holds the magnetic impulses or moments that store digital data, and media overcoat and lubricant layers to protect the magnetic recording layer. The typical disk drive also includes a read head and a write head, generally in the form of a magnetic transducer which can sense and/or change the magnetic moments stored on the recording layer of the disks.

Many magnetic recording disks for use in HDDs are configured for perpendicular magnetic recording (PMR). PMR, also known as conventional magnetic recording (CMR), operates by aligning the poles of magnetic elements of a magnetic recording layer (MRL) perpendicularly to the surface of the disk. The magnetic elements represent bits of data.

Enhanced PMR (ePMR) systems can increase the areal density of information recorded magnetically on various magnetic media, i.e., they provide better areal density capacity (ADC). With ePMR, an electrical current may be applied to the main pole of the write head of the disk drive during a write operation, which creates an additional magnetic field that reduces jitter in the write currents. This allows the write head to write more consistently to smaller tracks, thus increasing ADC.

The HDD media disk used within a PMR or ePMR system is often configured with a sputtered capping (or barrier) layer formed between a magnetic recording layer and a carbon overcoat (COC). The capping layer may be formed, e.g., of Co, Cr, Pt, Ru, and B. The capping layer is provided to, for example, (a) promote uniform inter-grain coupling to the magnetic recording layer to improve writability and (b) create a smooth surface for the carbon overcoat to improve corrosion resistance. Often, a surface planarization process, such as etching, is employed on the capping layer to achieve an even smoother surface to reduce magnetic spacing between the read/write head and the media and provide better corrosion robustness. However, the planarization process may also introduce too much grain coupling by displacing magnetic material leading to an undesirable increase in the width of magnetic bit tracks and poor jitter for bit transitions. This can result in lower areal density. Moreover, the capping layer may include a Co-rich alloy to provide a higher magnetic moment to promote a better signal in the write head, but this can reduce the robustness of corrosion resistance.

It would be desirable to provide an alternative material for use as a capping layer for HDD media and aspects of the present disclosure are directed to that end.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one embodiment, a magnetic recording medium is provided that includes: a substrate; a magnetic recording layer on the substrate; and a capping layer on the magnetic recording layer, wherein the capping layer comprises a magnetic material and carbon. The magnetic material may be, for example, Co—Pt. The capping layer may include, for example, an amount of carbon providing an atomic percentage (at. %) in the media in the range of 10-30 at. %. In some examples, the capping layer is CoPtC—X, where X is one or more of B, Cr, Ru, O, and Ta. The magnetic recording medium may include additional layers such as a soft underlayer (SUL) on the substrate, a seed layer on the SUL, and an interlayer on the seed layer, with the magnetic recording layer on the interlayer.

In another embodiment, a method for fabricating a magnetic recording medium is provided. The method includes: providing a substrate; providing a magnetic recording layer on the substrate; and providing a capping layer on the magnetic recording layer, wherein the capping layer comprises a magnetic material and carbon. Additional layers may be provided such as an SUL on the substrate, a seed layer on the SUL, and an interlayer on the seed layer, with the magnetic recording layer on the interlayer.

In another embodiment, a magnetic recording medium is provided that is configured for perpendicular magnetic recording. The magnetic recording medium includes: a substrate; an SUL on the substrate, wherein the SUL comprises a ferromagnetic material and one or more non-magnetic materials; a seed layer on the SUL, wherein the seed layer comprises Co or Ni; an interlayer on the seed layer, wherein the interlayer comprises Ru; a magnetic recording layer on the interlayer; and a capping layer on the magnetic recording layer, wherein the capping layer comprises a magnetic material and carbon. The magnetic material may be, e.g., Co—Pt. The capping layer may include, e.g., an amount of carbon providing an atomic percentage (at. %) in the media in the range of 10-30 at. %. In some examples, the capping layer is CoPtC—X, where X is one or more of B, Cr, Ru, O, and Ta.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods.

### BRIEF DESCRIPTION OF THE DRAWINGS

A more particular description is included below with reference to specific aspects illustrated in the appended drawings. Understanding that these drawings depict only certain aspects of the disclosure and are not therefore to be considered to be limiting of its scope, the disclosure is described and explained with additional specificity and detail through the use of the accompanying drawings, in which:

FIG. 1 is a top schematic view of an exemplary disk drive configured for perpendicular magnetic recording (PMR) or enhanced (ePMR) that includes a media disk with a magnetic capping layer containing carbon, in accordance with an aspect of the disclosure.

FIG. 2 is a side schematic view of the exemplary slider and media disk of FIG. 1 in accordance with an aspect of the disclosure.

FIG. 3 is a side schematic view of an exemplary magnetic recording medium configured for use with PMR or ePMR that includes, among other layers, a magnetic capping layer containing carbon, in accordance with an aspect of the disclosure.

FIG. 4 is a flowchart of an exemplary process for fabricating a PMR or ePMR medium that includes, among other layers, a magnetic capping layer containing carbon, in accordance with an aspect of the disclosure.

FIG. 5 is a side schematic view of another exemplary magnetic recording medium, in accordance with an aspect of the disclosure.

FIG. 6 is a flowchart of another exemplary process for fabricating a magnetic recording medium, in accordance with an aspect of the disclosure.

FIG. 7 is a graph showing corrosion resistance for a non-carbon capping layer and for a carbon-containing capping layer, in accordance with an aspect of the disclosure.

FIG. 8 is a graph showing etch loss for a non-carbon capping layer and for a carbon-containing capping layer, in accordance with an aspect of the disclosure.

FIG. 9 is a graph showing saturation magnetization (Ms) for a non-carbon capping layer and for a carbon-containing capping layer, for both etched and non-etched capping layers, in accordance with an aspect of the disclosure.

### DETAILED DESCRIPTION

In the following detailed description, reference is made to the accompanying drawings, which form a part thereof. In addition to the illustrative aspects, aspects, and features described above, further aspects, aspects, and features will become apparent by reference to the drawings and the following detailed description. The description of elements in each figure may refer to elements of proceeding figures. Like numbers may refer to like elements in the figures, including alternate aspects of like elements.

The disclosure relates in some aspects to apparatuses, systems, methods, and magnetic recording media for use perpendicular magnetic recording (PMR) or enhanced PMR (ePMR) or other magnetic recording systems such as heat-assisted magnetic recording (HAMR) or shingled magnetic recording (SMR). In particular, a magnetic recording medium is described for use within such systems where the magnetic recording medium is configured to, among other features, improve areal density and corrosion resistance and achieve other desirable characteristics such as improved signal to noise ratio (SNR).

In some aspects, these and other features are achieved by providing a capping layer (or barrier layer) for use in a magnetic recording medium where the capping layer includes carbon and a magnetic material. In some aspects, the magnetic capping layer may be a magnetic alloy that includes carbon with an atomic percentage (at. %) in the range of 10-30 at. %. The magnetic material may be, e.g., Co—Pt. In one particular example, the magnetic capping layer may be 54Co-21.5Pt-24.5C. In other examples, the alloy may be, for example, Co—Pt—C+X, where X is B/Cr/Ru/Ta or other suitable material and may include one or more oxides. (Note that CoPtC—X may be referred to alternatively as CoPtCX or Co—Pt—C+X or by using other suitable terminology to indicate that the compound includes Co, Pt, C and an additional element denoted X.) For example, the magnetic capping layer may be 60.5Co-2.5Cr-24Pt-3Ru-10C. Note that, in some aspects, it is the combination of Co and Pt that renders the material magnetic. In some aspects, the magnetic moment of the alloy is 500 electromagnetic unit of magnetic moment (emu) per cubic centimeter (cc) or higher, such as a magnetic moment in the range of 500-600 emu/cc. In some examples, other magnetic materials besides Co might be used such as iron (Fe). For example, in a HAMR system, Co may be replaced with Fe. In some aspects, the capping layer is smoother on its top surface (upon which a carbon overcoat may be formed) as compared to the lower surface of the capping layer (that is formed on the magnetic recording layer), e.g., the top surface may be 10% smoother than the bottom surface.

Among other advantages, the magnetic capping layer with carbon may suffer less damage during etching. In one example, the carbon-containing capping layer lost ⅓rd less material during etching as compared to a conventional capping layer. Moreover, the carbon magnetic capping layer may suffer less of a reduction in saturation magnetization (Ms) during etching as compared to a conventional capping layer, e.g., 10% less loss of Ms. (See, for example, data discussed below.) As compared to a conventional capping layer, the carbon-containing magnetic capping layer may improve writability while also providing additional corrosion protection beyond what the carbon overcoat provides. The presence of carbon in the capping layer can also improve mechanical robustness.

Herein-below, examples are described wherein the magnetic recording medium is configured for PMR or ePMR, but the medium may be configured for use with other recording systems such as HAMR. Prior to describing the examples, a data storage device is described for use with ePMR where a current delivery element is provided in the write head for applying an electrical current to the main pole of the write head during the write operation. It should be understood that a similar data storage device may be provided for HAMR that would instead include a laser heating element in the slider, and a similar data storage device may be provided for PMR that would omit the ePMR current delivery element and the HAMR laser.

### Data Storage Device Example

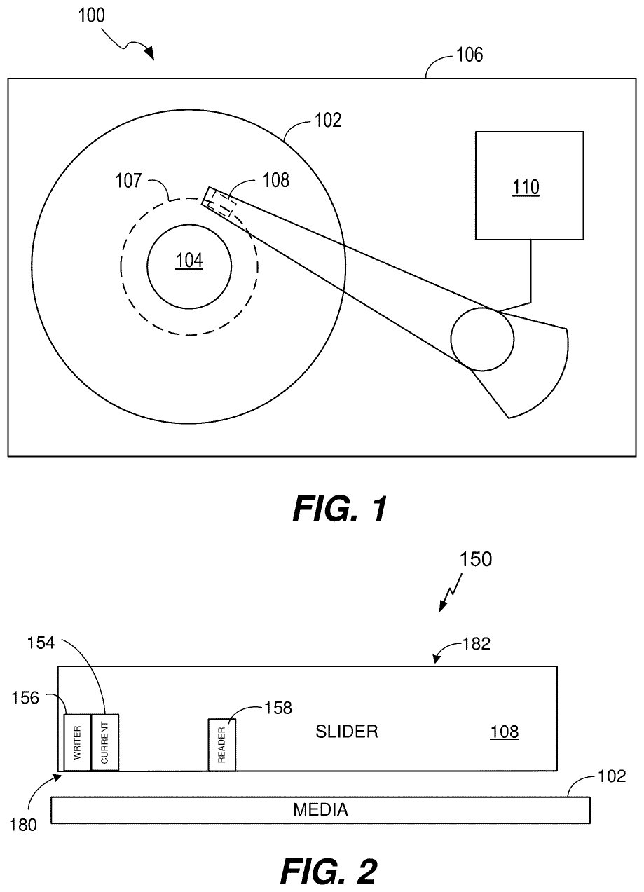

FIG. 1 is a top schematic view of a data storage device 100 configured for magnetic recording and including a disk-shaped magnetic recording medium 102 in accordance with some aspects of the disclosure. In illustrative examples, the magnetic recording medium 102 is configured for PMR). The magnetic recording medium 102 may be configured with a capping layer that includes carbon and magnetic materials. In some aspects, the magnetic capping layer may be a magnetic alloy that includes carbon with an atomic percentage (at. %) in the range of 10-30 at. %. The magnetic material may be, e.g., Co—Pt. In one particular example, the magnetic capping layer may be 54Co-21.5Pt-24.5C. However, other recording media, such as media configured for HAMR or microwave assisted magnetic recording (MAMR) may be used in other examples. The data storage device 100 may include one or more disks/media 102 to store data. Disk/media 102 resides on a spindle assembly 104 that is mounted to drive housing 106. Data may be stored along tracks 107 along the magnetic recording layer of disk 102.

The reading and writing of data are accomplished with the head/slider 108 that may have both read and write elements. The write element is used to alter the properties of the magnetic recording layer of disk 102 and thereby write information thereto. In one embodiment, recording head 108 may have magneto-resistive (MR), or giant magneto-resistive (GMR) elements, such as tunnel magneto-resistive (TMR) elements for reading, and a write pole with coils that can be energized for writing. In another embodiment, head 108 may be another type of head, for example, an inductive read/write head or a Hall effect head. For ePMR, the write head includes a current delivery element to apply an electrical current to the main pole of the write head during the write operation (see, FIG. 2). In operation, a spindle motor (not shown) rotates the spindle assembly 104, and thereby rotates disk 102 to position head 108 at a particular location along a desired disk track 107. The position of the head 108 relative to the disk 102 may be controlled by position control circuitry 110.

FIG. 2 illustrates a profile view of the slider 108 and the magnetic recording medium 102 of FIG. 1 in accordance with some aspects of the disclosure. In particular, FIG. 2 illustrates an assembly 150 that includes the slider 108, a current application device 154, a writer 156, and a reader 158. For ePMR, the current delivery device 154 or circuit is connected to the writer 156 to apply an electrical current to the main pole of the write head during the write operation. The current delivery device 154 may be omitted for a non-enhanced PMR drive. For HAMR, the current delivery device 154 may be replaced with a near-field transducer (NFT) for delivering heat to the media 102. Other components may be used instead of an NFT (e.g., a spin torque oscillator (STO) in a microwave assisted magnetic recording (MAMR) head). It is noted that FIG. 2 is not drawn to scale and generally the slider 108 is substantially smaller than the media 102 (e.g., as shown in FIG. 1). The assembly 150 is positioned over the media 102. The slider 108 may be one component or several components. The slider 108 may include a slider body and a slider head. In some implementations, a slider head may be a separate component that may be integrated with the slider 108. The writer 156 and the reader 158 may be implemented in the slider, the slider head, or combinations thereof.

The slider 108 includes a first surface 180 (e.g., bottom surface) that faces the media 102. The first surface 180 may be referred to as an air bearing surface (ABS). The slider 108 also includes a second surface 182 (e.g., top surface) that faces away from the media 102. The writer 156 and the reader 158 may be located near or along the first surface 180 of the slider 108. The writer 156 may be a writing element (e.g., means for writing data) for writing data on the media 102, and the reader 158 may be a reading element (e.g., means for reading data) for reading data on the media 102. As noted, the writer 156 may include a write pole.

### PMR Media Example

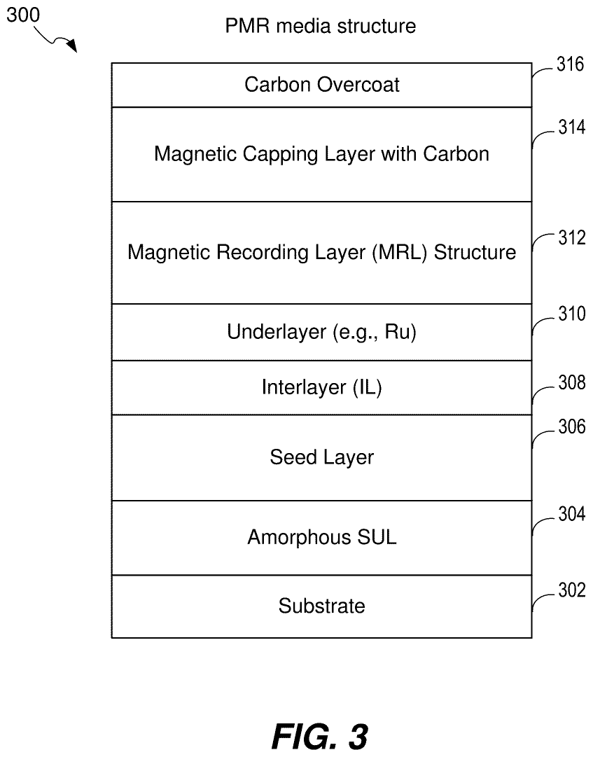

FIG. 3 is a side cross-sectional schematic view of a magnetic recording medium 300 configured for use with PMR that includes a capping layer that includes carbon and magnetic materials, in accordance with an aspect of the disclosure. The magnetic recording medium 300 has a stacked structure. In sequence from the bottom, the medium 300 includes a substrate 302, an amorphous SUL 304, a seed layer 306, an interlayer 308, an underlayer 310, an MRL structure 312, the capping layer 314, and a carbon overcoat 316. Although not shown, a lubricant may be applied on the carbon overcoat 316. In some aspects, the magnetic capping layer 314 may be a magnetic alloy that includes carbon in the range of 10-30 at. %, or the narrower range of 20-30 at. %, or the narrower range of 25-30 at. %. The magnetic material may be, e.g., Co—Pt. In one particular example, the magnetic capping layer is 54Co-21.5Pt-24.5C. In other examples, the alloy may be, for example, CoPtC—X, where X is B/Cr/Ru/Ta or other suitable material and may include one or more oxides. For example, the magnetic capping layer may be 60.5Co-2.5Cr-24Pt-3Ru-10C. In some aspects, the magnetic moment of the alloy is 500 emu/cc or higher, such as a magnetic moment in the range of 500-600 emu/cc. In some aspects, the capping layer 314 is smoother on its top surface (upon which the carbon overcoat 316 is formed) as compared to the lower surface of the capping layer 314 (formed on the magnetic recording layer 312), e.g., the top surface may be 10% smoother than the bottom surface. In some examples, the MRL structure 312 has multiple magnetic recording layers and multiple non-magnetic ECLs. In some examples, the MRL may be configured with alternating ECLs and oxide magnetic layers, where the oxide magnetic layer may include a CoCrPt-oxide material. Additional layers or films may be provided. Some layers may be omitted.

The terms “above,” “below,” “on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

In the following, some illustrative details are providing regarding the various layers. These details are merely exemplary.

The substrate 302 can be made of one or more materials such as an aluminum (Al) alloy, nickel-phosphorus (NiP)-plated Al, glass, glass ceramic, and/or combinations thereof. In one embodiment, the substrate 302 may be a rigid substrate (e.g., glass or ceramic).

The amorphous SUL 304 can be made of one or more ferromagnetic materials with high permeability, high saturation magnetization and low coercivity, such as cobalt (Co) or iron (Fe). The amorphous SUL 304 may include an amorphous compound or combination of Co and Fe (e.g., a CoFe alloy) with the addition of one or more non-magnetic elements from as molybdenum (Mo), tantalum (Ta), niobium (Nb), boron (B), chromium (Cr), tungsten (W), and Zirconium (Zr). The SUL 304 may be configured to support magnetization of the magnetic recording layer structure 312 during data storage operations. More specifically, the amorphous SUL 304 may be configured to provide a return path for a magnetic field applied during a write operation. The amorphous SUL 304 has a thickness in the range of 80 to 300 Angstroms. In one embodiment, the thickness of the amorphous SUL 304 is 150 Angstroms.

The seed layer 306 may be formed, e.g., of Co or Ni a thickness in the range of 20 to 40 Å. The seed layer provides a specific crystal structure to facilitate growth of the MRL and promote perpendicular magnetization.

The interlayer 308, which is optional in some embodiments, may be formed of Ru and a secondary material such as Co and Cr. For example, the interlayer, formed on the seed layer, may be provided to promote lattice matching between the seed layer and the underlayer, which in turn helps to maintain proper crystallographic texture of the magnetic recording layers. (Crystallographic texture generally refers to the distribution of crystallographic orientations of a polycrystalline structure.)

The underlayer 310, which is optional in some embodiments, may be made of one or more materials such as Ru and/or other suitable materials known in the art. The underlayer may be, for example, sputter deposited onto the interlayer to achieve a desired grain size and topography to facilitate growth of small magnetically-decoupled grains within the MRL structure that is grown on the underlayer.

The MRL 312 may be made of CoPt. In some examples, the crystallographic orientation of the MRL 312 can be configured to facilitate PMR or ePMR. The MRL structure that may be, e.g., 100-200 Å thick. For HAMR, the MRL may be made of, e.g., FePt or CoPt.

The magnetic capping layer 314 may be, as described above, a magnetic alloy that includes carbon in the range of 10-30 at. %. The magnetic material may be, e.g., Co—Pt. In one particular example, the magnetic capping layer is 54Co-21.5Pt-24.5C. The capping layer 318 thickness may be, e.g., in the range of 1 nanometer (nm) to 3 nm.

The overcoat 316 may be a carbon overcoat such as a diamond-like carbon (DLC) overcoat. The overcoat 316 thickness may be in the range of 10 Å to 30 Å.

The lubricant, if provided, may be a polymer-based lubricant such as perfluoropolyether (PFPE) and/or other suitable materials known in the art and have a thickness in the range of 7 Å to 9.5 Å.

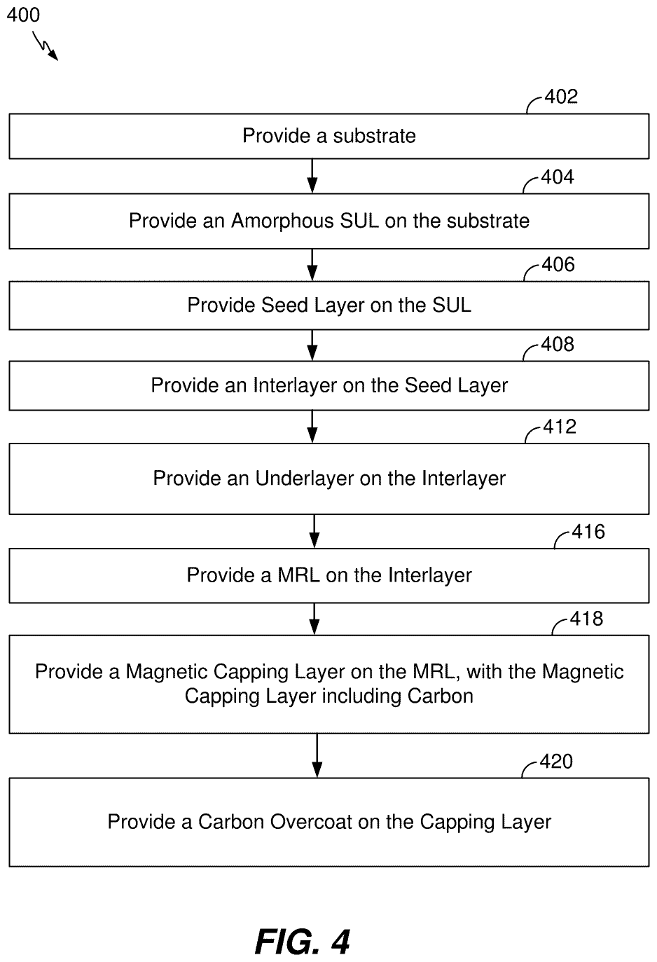

FIG. 4 is a flowchart of a process 400 for fabricating a PMR medium. In particular embodiments, the process 400 can be used to fabricate the magnetic recording media described above as medium 300. At block 402, the process provides a substrate. At block 404, a soft magnetic underlayer (e.g., SUL 304 in FIG. 3) is provided on the substrate. At block 406, a seed layer is provided on the SUL. At block 408, an interlayer is provided on the seed layer. At block 410, an underlayer may optionally be provided on the interlayer. The underlayer may be made of one or more materials such as Ru and/or other suitable materials known in the art. At block 412, a magnetic recording layer structure (e.g., MRL structure 312 in FIG. 3) is provided on the underlayer. In some embodiments, the magnetic recording layer structure has or includes multiple non-magnetic ECLs. In some examples, the MRL may be configured with alternating ECLs and oxide magnetic layers. In block 418, the process provides a magnetic capping layer on the MRL where the magnetic capping layer includes carbon, as described above. The capping layer may be sputter deposited. Following deposition, a surface planarization process may be applied, such as etching. In block 420, the process provides a carbon overcoat. The process may also provide a lubricant layer on the overcoat. Additional or alternative exemplary materials are listed above.

Insofar as the processes described herein are concerned, the processes can in some cases perform the sequence of actions in a different order. In another aspect, the process can skip one or more of the actions. In other aspects, one or more of the actions are performed simultaneously. In some aspects, additional actions can be performed. The deposition of at least some of the layers can be performed using any of a variety of deposition processes or sub-processes, including, but not limited to physical vapor deposition (PVD), DC sputter deposition and ion beam deposition, plasma enhanced chemical vapor deposition (PECVD) and other forms of chemical vapor deposition (CVD) besides PECVD, low pressure chemical vapor deposition (LPCVD) and atomic layer chemical vapor deposition (ALCVD). In other aspects, other suitable deposition techniques known in the art might also be used. As noted above, DC sputtering may advantageously be employed to form the amorphous metal overcoat.

### Additional Examples and Embodiments

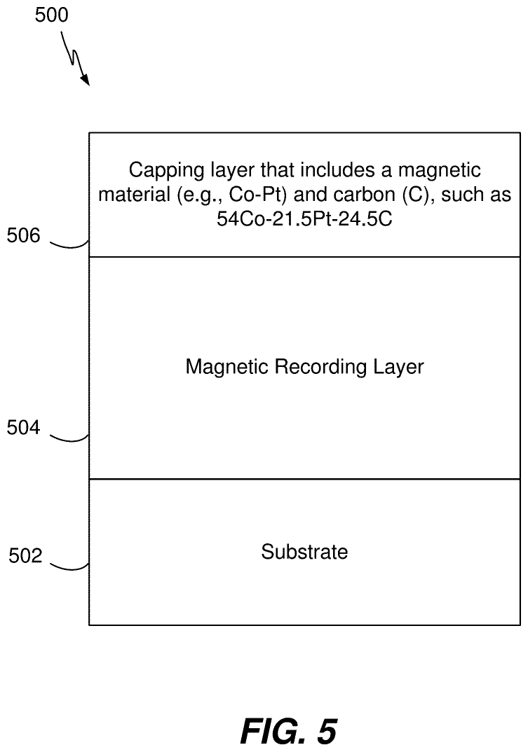

FIG. 5 is a side schematic view of an exemplary magnetic recording medium 500 in accordance with another aspect of the disclosure. The magnetic recording medium 500 has a stacked structure with a substrate 502, an MRL 504 on the substrate 502, and a capping layer 506 on the MRL where the capping layer 506 includes a magnetic material and carbon. In some aspects, the capping layer 506 may be a magnetic alloy that includes carbon in the range of 10-30 at. %, or the narrower range of 20-30 at. %, or the narrower range of 25-30 at. %. The magnetic material may be, e.g., Co—Pt. In one particular example, the magnetic capping layer is 54Co-21.5Pt-24.5C. In other examples, the alloy may be, for example, CoPtC—X, where X is B/Cr/Ru/Ta or other suitable material and may include one or more oxides. For example, the magnetic capping layer may be 60.5Co-2.5Cr-24Pt-3Ru-10C. In some aspects, the magnetic moment of the alloy is 500 emu/cc or higher, such as a magnetic moment in the range of 500-600 emu/cc. In some aspects, the capping layer 506 is smoother on its top surface (upon which a carbon overcoat may be formed) as compared to the lower surface of the capping layer 506 (that is formed on the magnetic recording layer 504), e.g., the top surface may be 10% smoother than the bottom surface. In some examples, the MRL structure 504 has multiple magnetic recording layers and multiple non-magnetic ECLs. In some examples, the MRL may be configured with alternating ECLs and oxide magnetic layers. Additional layers or films may be provided, such as those shown in FIG. 3 and described above.

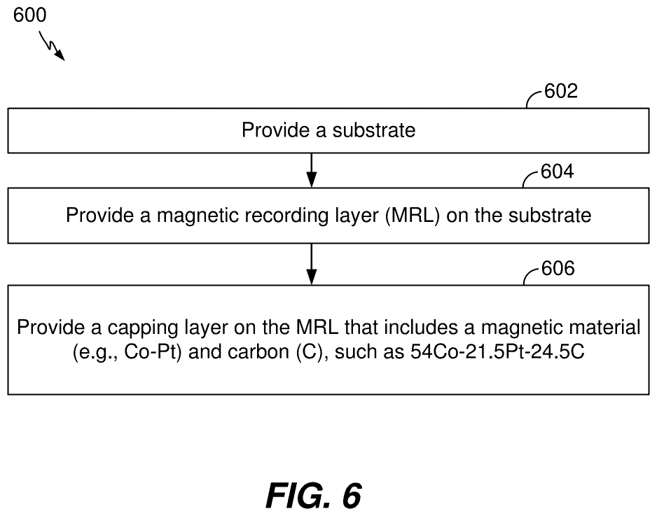

FIG. 6 is a flowchart of a process 600 for fabricating a magnetic recording medium. In particular embodiments, the process 600 can be used to fabricate the magnetic recording media described above. At block 602, the process provides a substrate. At block 604, an MRL is provided on the substrate. In block 606, the process provides a capping layer on the MRL where the capping layer includes a magnetic material and carbon. In some aspects, the capping layer may be a magnetic alloy that includes carbon in the range of 10-30 at. %, or the narrower range of 20-30 at. %, or the narrower range of 25-30 at. %. The magnetic material may be, e.g., Co—Pt. In one particular example, the magnetic capping layer is 54Co-21.5Pt-24.5C. In other examples, the alloy may be, for example, CoPtC—X, where X is B/Cr/Ru/Ta/O(oxide) or other suitable material. For example, the magnetic capping layer may be 60.5Co-2.5Cr-24Pt-3Ru-10C. In some aspects, the magnetic moment of the alloy is 500 emu/cc or higher, such as a magnetic moment in the range of 500-600 emu/cc. In some aspects, the capping layer is smoother on its top surface (upon which a carbon overcoat may be formed) as compared to the lower surface of the capping layer (that is formed on the magnetic recording layer), e.g., the top surface may be 10% smoother than the bottom surface. In some examples, the MRL formed at block 64 has multiple magnetic recording layers and multiple non-magnetic ECLs. In some examples, the MRL may be configured with alternating ECLs and oxide magnetic layers. Additional layers or films may be provided, such as those shown in FIG. 3.

### Exemplary Test Results

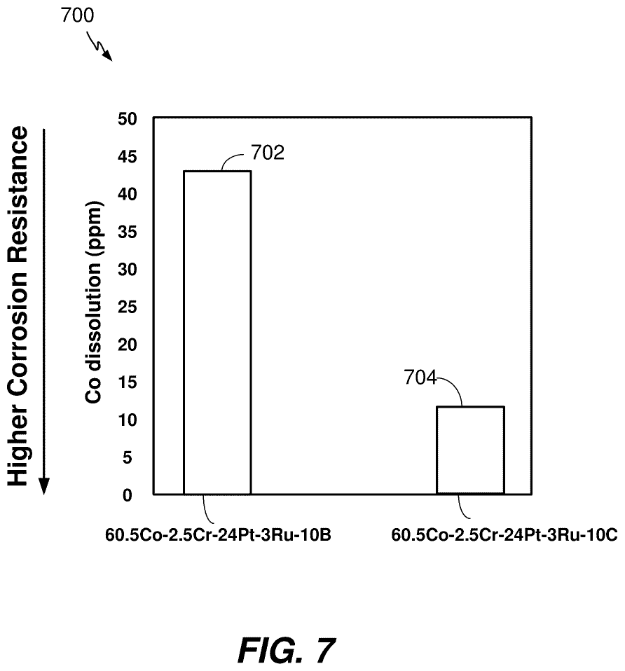

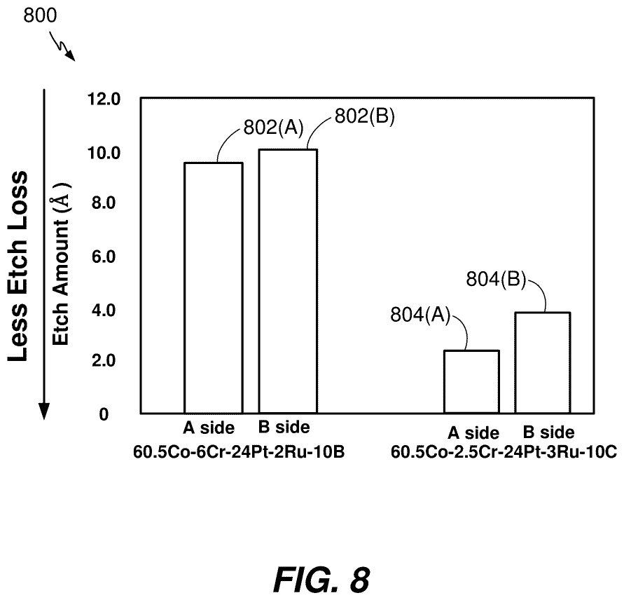

FIG. 7 is a graph 700 showing exemplary corrosion resistance for a non-carbon containing capping layer 702 formed of 60.5Co-2.5Cr-24Pt-3Ru-10B and a carbon containing capping layer 704 formed of 60.5Co-2.5Cr-24Pt-3Ru-10C. Capping layer 704 substitutes 10C for 10B but has an equal at. % of Cr (i.e., 2.5Cr). Within FIG. 7, the y-axis represents corrosion resistance in units of Co dissolution in parts per million (PPM) with lower Co dissolution indicating higher corrosion resistance. As shown, carbon containing capping layer 704 shows much better corrosion resistance for an equal amount of Cr in the alloy. It is noted that similar improvements in corrosion resistance can be achieved with a non-carbon containing capping layer by significantly increasing the Cr in the alloy, such as by using 58Co-6Cr-24Pt-2Ru-10B. However, the higher Cr reduces the magnetic moment and lowers amplitudes, thus reducing areal recording density and SNR. In other words, by employing carbon within the capping layer, high corrosion resistance can be achieved without requiring an increase in Cr which would reduce the layer magnetic moment.

FIG. 8 is a graph 800 showing an exemplary amount of material loss from the capping layer during an etch process for a non-carbon containing capping layer formed of 60.5Co-6Cr-24Pt-2Ru-10B and a carbon containing capping layer formed of 60.5Co-2.5Cr-24Pt-3Ru-10C. Note that for both compounds, the amount of etch was measured for both the “A” side of a media disk with the capping layer and for the opposite “B” side of the disk. 802(A) indicates the A side measurement for 60.5Co-6Cr-24Pt-2Ru-10B. 802(B) indicates the B side measurement for 60.5Co-6Cr-24Pt-2Ru-10B. 804(A) indicates the A side measurement for 60.5Co-2.5Cr-24Pt-3Ru-10C. 804(B) indicates the B side measurement for 60.5Co-2.5Cr-24Pt-3Ru-10C. Within FIG. 8, the y-axis represents the etch amount in Å, that is, the amount of material that is etched away during a planarization process. Less etch loss is better. As shown, the carbon containing capping layer 804 shows significantly less etch loss than the non-carbon containing capping layer 802. Indeed, for the same etching process, the carbon capping layer suffered about ⅓rd less etch loss that the non-carbon capping layer. Since the carbon-containing capping layer suffers less damage with etching, the write width can be narrower to achieve better SNR and better ADC. The amount of etch loss also affects the saturation magnetization (Ms) of the media, as discussed next.

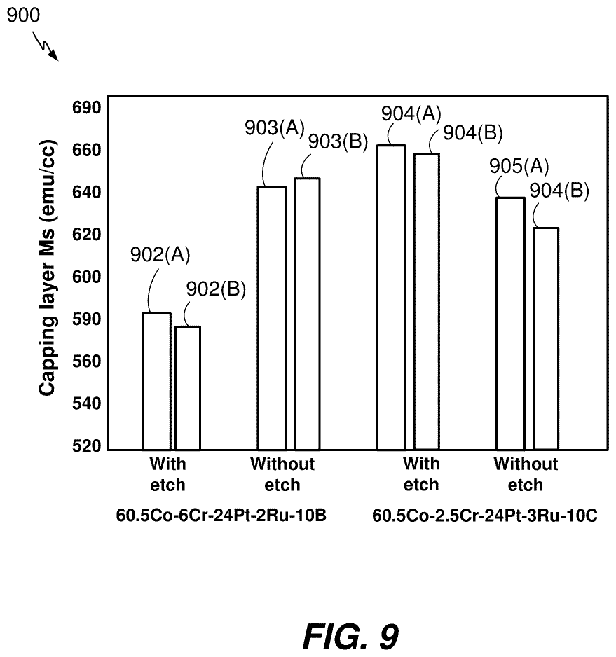

FIG. 9 is a graph 900 showing an exemplary amount of loss in Ms occurring due to etching for a non-carbon containing capping layer formed of 60.5Co-6Cr-24Pt-2Ru-10B and a carbon containing capping layer formed of 60.5Co-2.5Cr-24Pt-3Ru-10C. Note that for both compounds, the amount of Ms loss was measured for both the A side of a media disk with the capping layer and for the opposite B side of the disk and also for both an etched layer and a non-etched layer. 902(A) indicates the A side Ms measurement for 60.5Co-6Cr-24Pt-2Ru-10B with etch. 902(B) indicates the B side Ms measurement for the same compound with etch. 903(A) indicates the A side Ms measurement for 60.5Co-6Cr-24Pt-2Ru-10B without etch. 903(B) indicates the B side Ms measurement for the same compound without etch. 904(A) indicates the A side Ms measurement for 60.5Co-2.5Cr-24Pt-3Ru-10C with etch. 904(B) indicates the B side Ms measurement for the same compound with etch. 905(A) indicates the A side Ms measurement for 60.5Co-2.5Cr-24Pt-3Ru-10C with etch. 904(B) indicates the B side Ms measurement for the same compound without etch.

Within FIG. 9, the y-axis represents the Ms for the capping layer in emu/cc. As shown, for the non-carbon capping layer 60.5Co-6Cr-24Pt-2Ru-10B, there is significant loss of Ms from etching. In contrast, for the carbon capping layer 60.5Co-2.5Cr-24Pt-3Ru-10C, there is far less loss of Ms from etching. That is, the tested carbon containing capping layer (60.5Co-2.5Cr-24Pt-3Ru-10C) exhibited 10% less of a loss in Ms due to etching as compared to the non-carbon containing capping layer (60.5Co-6Cr-24Pt-2Ru-10B). It is noted that when using 60.5Co-2.5Cr-24Pt-3Ru-10C, the loss of Ms is not nearly as great as compared to 60.5Co-6Cr-24Pt-2Ru-10B. Nevertheless, as discussed above, 60.5Co-2.5Cr-24Pt-3Ru-10C provides far less corrosion resistance than 60.5Co-2.5Cr-24Pt-3Ru-10C.

### Additional Aspects

The examples set forth herein are provided to illustrate certain concepts of the disclosure. The apparatuses, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatuses, systems, and computer program products according to aspects of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding aspects. For instance, an arrow may indicate a waiting or monitoring period of unspecified duration between enumerated steps of the depicted aspect.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example aspects. The example systems and components described herein may be configured differently than described. For example, elements may be added to, removed from, or rearranged compared to the disclosed example aspects.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific aspects of the invention, these should not be construed as limitations on the scope of the invention, but rather as examples of specific aspects thereof. Accordingly, the scope of the invention should be determined not by the aspects illustrated, but by the appended claims and their equivalents. Moreover, reference throughout this specification to “one aspect,” “an aspect,” or similar language means that a particular feature, structure, or characteristic described in connection with the aspect is included in at least one aspect of the present disclosure. Thus, appearances of the phrases “in one aspect,” “in an aspect,” and similar language throughout this specification may, but do not necessarily, all refer to the same aspect, but mean “one or more but not all aspects” unless expressly specified otherwise.

The terminology used herein is for the purpose of describing particular embodiments only and is not intended to limit the embodiments. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on. The term “about ‘value X’”, or “approximately value X,” as used in the disclosure shall mean within 10 percent of the 'value X'. For example, a value of about 1 or approximately 1, would mean a value in a range of 0.9-1.1. In one aspect, “about” as used herein may instead mean 5 percent. In this disclosure, various numerical values are presented. Unless specifically indicated otherwise, it is contemplated that these numerical values may have a tolerance of 10 percent. In another aspect, the tolerance may be 5 percent. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range. Various components described in this specification may be described as “including” or made of certain materials or compositions of materials. In one aspect, this can mean that the component consists of the particular material(s). In another aspect, this can mean that the component comprises the particular material(s).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

1. A magnetic recording medium, comprising:
a substrate;
a magnetic recording layer on the substrate; and
a capping layer on the magnetic recording layer,
wherein the capping layer comprises CoPtC.

2. The magnetic recording medium of claim 1, wherein the capping layer comprises an atomic percentage (at. %) of C in the range of 10-30 at. %.

3. The magnetic recording medium of claim 1, wherein the capping layer comprises CoPtC—X, where X is one or more of B, Cr, Ru, O, and Ta.

4. The magnetic recording medium of claim 1, wherein the capping layer comprises 60.5Co-2.5Cr-24Pt-3Ru-10C.

5. (canceled)

6. (canceled)

7. The magnetic recording medium of claim 1, wherein the capping layer comprises an atomic percentage (at. %) of Co of at least 40 at. %.

8. The magnetic recording medium of claim 1, wherein the magnetic recording medium is configured for perpendicular magnetic recording and further comprises:
a soft underlayer (SUL) on the substrate, wherein the SUL comprises a ferromagnetic material and one or more non-magnetic elements;
a seed layer on the SUL, wherein the seed layer comprises Co or Ni;
an interlayer on the seed layer, wherein the interlayer comprises Ru; and
wherein the magnetic recording layer is on the interlayer.

9. A data storage device comprising:
a slider comprising a magnetic recording head; and
the magnetic recording medium of claim 1,
wherein the slider is configured to write information to the magnetic recording layer of the magnetic recording medium using perpendicular magnetic recording (PMR).

10. The data storage device of claim 9, wherein the slider comprises a writer configured to write the information by applying an electrical current to a main pole of the writer during a write operation.

11. A method for fabricating a magnetic recording medium, the method comprising:
providing a substrate;
providing a magnetic recording layer on the substrate; and
providing a capping layer on the magnetic recording layer,
wherein the capping layer comprises CoPtC.

12. The method of claim 11, wherein the capping layer comprises an atomic percentage (at. %) of C in the range of 10-30 at. %.

13. The method of claim 11, wherein the capping layer comprises CoPtC—X, where X is one or more of B, Cr, Ru, O, and Ta.

14. The method of claim 11, wherein the capping layer comprises 60.5Co-2.5Cr-24Pt-3Ru-10C.

15. (canceled)

16. (canceled)

17. The method of claim 11, wherein the capping layer comprises Co with an atomic percentage (at. %) of at least 40 at. %.

18. The method of claim 11, further comprising:
providing a soft underlayer (SUL) on the substrate, wherein the SUL comprises a ferromagnetic material and one or more non-magnetic materials;
providing a seed layer on the SUL, wherein the seed layer comprises Co or Ni;
providing an interlayer on the seed layer, wherein the interlayer comprises Ru; and
wherein the magnetic recording layer is provided on the interlayer.

19. A magnetic recording medium configured for perpendicular magnetic recording, the magnetic recording medium comprising:
a substrate;
a soft underlayer (SUL) on the substrate, wherein the SUL comprises a ferromagnetic material and one or more non-magnetic materials;
a seed layer on the SUL, wherein the seed layer comprises Co or Ni;
an interlayer on the seed layer, wherein the interlayer comprises Ru;
a magnetic recording layer on the interlayer; and
a capping layer on the magnetic recording layer,
wherein the capping layer comprises CoPtC.

20. The magnetic recording medium of claim 19, wherein the capping layer comprises an atomic percentage (at. %) of C in the range of 10-30 at. %.

21. The magnetic recording medium of claim 1, wherein a top surface of the capping layer has less surface roughness than that of a bottom surface of the capping layer, the bottom surface directly on the magnetic recording layer.

22. The magnetic recording medium of claim 1, wherein the capping layer comprises Co, Cr, Pt, Ru, and C.

23. The magnetic recording medium of claim 1:
wherein the magnetic recording layer comprises CoPt; and
wherein the Co in the capping layer has an atomic percentage (at. %) of at least 40 at. %.

24. The method of claim 11, wherein a top surface of the capping layer has less surface roughness than that of a bottom surface of the capping layer, the bottom surface directly on the magnetic recording layer.

25. The method of claim 11, wherein the capping layer comprises Co, Cr, Pt, Ru, and C.

26. The method of claim 11:
wherein the magnetic recording layer comprises CoPt; and
wherein the Co in the capping layer has an atomic percentage (at. %) of at least 40 at. %.

27. The magnetic recording medium of claim 1, wherein the magnetic recording layer comprises FePt.

28. The method of claim 11, wherein the magnetic recording layer comprises FePt.
